(19) United States
(12) Patent Application Publication
(10) Pub. No.: US 2013/0034261 A1
(43) Pub. Date: Feb. 7, 2013

(54) Road sign detection and tracking within field-of-view (FOV) video data

(71) Applicant: QUANTUM SIGNAL, LLC, Saline, MI (US)

(72) Inventors: Victor E. Perlin, Burlington, MA (US); David B. Johnson, Ann Arbor, MI (US); Mitchell M. Rohde, Saline, MI (US)

(73) Assignee: QUANTUM SIGNAL, LLC, Saline, MI (US)

(21) Appl. No.: 13/649,644

(22) Filed: Oct. 11, 2012

Related U.S. Application Data
(63) Continuation-in-part of application No. 13/411,598, filed on Mar. 4, 2012, now abandoned.
(60) Provisional application No. 61/449,346, filed on Mar. 4, 2011.

(51) Int. Cl. G06K 9/00

(52) U.S. Cl. 382/100

(57) ABSTRACT

Road signs are recognized within field-of-view (FOV) video data having frames. Within a first stage, one or more candidate road signs within the FOV video data are identified, by statically analyzing each frame of the FOV video data independently to detect the one or more candidate road signs within the FOV video data. Within a second stage, each candidate road sign is confirmed or rejected as an actual candidate road sign within the FOV video data by dynamically analyzing the frames of the FOV video data interdependently. The first stage is a static analysis that considers each frame of the FOV video data independently. The second stage is a dynamic analysis that considers the frames of the FOV video data interdependently.

### RELATED APPLICATIONS

The present patent application is a continuation-in-part of the previously filed and presently pending patent application entitled “road sign recognition,” filed on Mar. 4, 2012, and assigned patent application Ser. No. 13/411,598, which itself claims priority to the previously filed provisional patent application entitled “enhanced situational awareness via road sign recognition,” filed on Mar. 4, 2011, and assigned patent application No. 61/449,346.

GOVERNMENTAL RIGHTS IN THE INVENTION

The invention that is the subject of this patent application was made with Government support under Contract No. W56HZV-09-C-0039 awarded by the U.S. Army Contracting Command. The Government has certain rights in this invention. Specifically, the Government shall have a nonexclusive, nontransferable, irrevocable, paid-up license to practice, or have practiced for or on its behalf, the subject invention throughout the world. The details of these rights can be reviewed in the contract document.

### BACKGROUND

Situational awareness in the context of vehicles and other types of scenarios refers to determining where one is located relative to one's surroundings. In the context of vehicles on roadways, such situational awareness is commonly employed as part of navigation systems to direct drivers to their intended destinations. Situational awareness is also used in military scenarios in which manned and unmanned vehicles and troops have to determine their locations in often hostile surroundings.

Current situational awareness techniques typically employ satellite-based positioning technologies, such as the global positioning system (GPS), to determine the latitude and longitude of one's location. This information can then be referenced against a geographical information system (GIS) to place the location against a map of existing landmarks, such as roads, points of interest, and so on. The resulting map may be displayed to a driver, for instance, and the information also used in the context of navigational directions to guide the driver to his or her intended destination.

### SUMMARY

A method for road sign detection and tracking within field-of-view (FOV) video data having multiple frames includes the following in one example technique disclosed herein. Within a first stage, the method includes identifying one or more candidate road signs within the FOV video data, by statically analyzing each frame of the FOV video data independently using a processor of a computing device to detect the candidate road signs within the FOV video data. Within a second stage, performed after the identifying the candidate road signs in the first stage, the method includes confirming or rejecting each candidate road sign as an actual candidate road sign, by dynamically analyzing the frames of the FOV video data interdependently using the processor. The first stage is a static analysis that considers each frame independently, and the second stage is a dynamic analysis that considers the frames interdependently.

For instance, the first stage can include the following. Each frame is segmented into regions of at least substantially uniform color, and which each represents a potential candidate road sign. Each region is tested against predetermined actual road sign types. If a region matches any predetermined actual road sign type, then it is specified as being a candidate road sign within the FOV video data. If a region does not match any predetermined actual road sign type, then it is specified as not being a candidate road sign within the FOV video data. Furthermore, for instance, the second stage can include employing a voting-oriented feature-tracking methodology that presumes movement of an actual road sign within the FOV video data is rigid and that is based upon motion of features at edges between foreground sign areas and background sign areas within a candidate road sign. If the candidate road sign fails the second stage, then it is not confirmed as an actual candidate road sign.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of an example method for road sign detection and tracking within field-of-view (FOV) video data.

FIG. 2 is a diagram of example illustrative performance of the road sign detection and tracking method of FIG. 1.

FIG. 3 is a flowchart of an example method for performing a first stage, static analysis to identify candidate road signs within the FOV video data in the method of FIG. 1.

FIG. 4 is a flowchart of an example method for performing a second stage, dynamic analysis to confirm or reject each candidate road sign identified within the FOV video data in the method of FIG. 1.

FIG. 5 is a diagram of an example system for situation awareness in which road sign detection and tracking is performed.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the embodiment of the invention is defined only by the appended claims.

As noted in the background section, many current situational awareness techniques employ satellite-based positioning technologies, such as the global positioning system (GPS). These techniques can be disadvantageous for a number of reasons. In military scenarios, satellite signals are easily jammed. In both military and non-military applications, satellite signals are sometimes not received with sufficient reliability. Furthermore, in non-military applications, the locational resolution that such satellite-based positioning technologies afford is purposefully degraded by the military.

As disclosed in the provisional patent application referenced above, a new technique that overcomes these disadvantages recognizes road signs to achieve situational awareness in lieu of using satellite-based positioning technologies. As a general matter, as a vehicle travels along a road, a camera is used to capture video of the roadside, including road signs that are commonly found along most roads globally. These road signs are recognized and interpreted to provide situational awareness, particularly where the information interpreted from the road signs is referenced against an appropriate geographical information system (GIS).

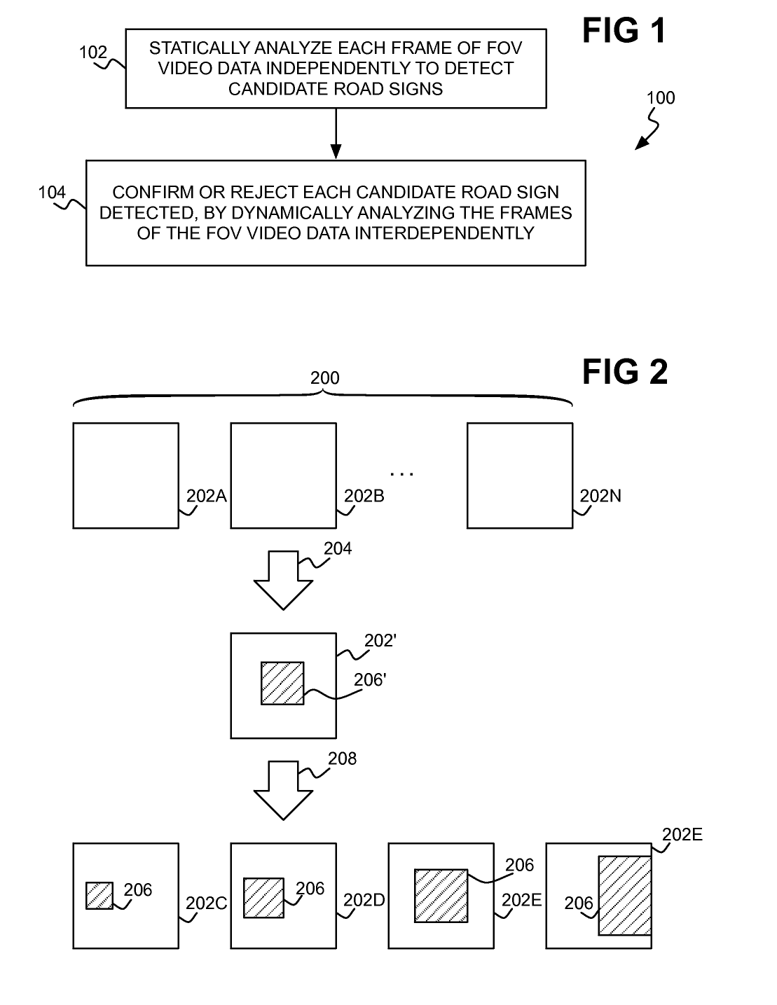

Disclosed herein are techniques to ensure that road signs within field-of-view (FOV) video data that may be captured by such cameras are properly detected and tracked. FIG. 1, for instance, depicts an example method 100 for road sign detection and tracking that is a two-stage process. In the first stage (102), corresponding to road sign detection, candidate road signs within the FOV video data are identified. In the second stage (104), corresponding to road sign tracking, each candidate road sign is confirmed or rejected as an actual candidate road sign within the FOV video data. The first stage of part 102 is a static analysis that considers each frame of the FOV video data independently and separately. The second stage of part 104 is a dynamic analysis that considers the frames of the FOV video data interdependently to confirm or each candidate road sign as an actual candidate road sign or as a false positive that was detected in the first stage.

The example technique of FIG. 1 thus answers two questions in succession. By statically analyzing each frame separately in the first stage of part 102, the question “what are potential (i.e., candidate) road signs that are within the FOV video data” is answered. By dynamically analyzing the frames interdependently in the second stage of part 104, the question “is each potential candidate road sign that has been identified in the first stage actually a candidate road sign” is answered. The second stage is thus a culling down of the candidate road signs identified in the first stage to yield actual candidate road signs. The first stage is a static analysis in that each frame of the FOV video data is considered separately, apart from the other frames. The second stage is a dynamic analysis in that multiple frames of the FOV video data are considered in unison, or interdependently, to determine whether each candidate road sign has proper motion throughout these frames to be accurately and properly confirmed as an actual candidate road sign.

FIG. 2 illustratively depicts a representative example performance of the method 100 and its two constituent stages. FOV video data 200 may be recorded by a camera attached to a moving vehicle. The FOV video data 200 includes a number of frames 202A, 202B, . . . , 202N, which are collective referred to as the frames 202. In the first stage, as denoted by the arrow 204, each frame 202 is analyzed by itself to locate potential road signs within the FOV video data 200. For instance, in FIG. 2, a potential road sign 206 has been identified within frame 202′, which is one of the frames 202 of the FOV video data 200.

In the second stage, as denoted by the arrow 208, the potential road signs that have been identified in the first stage are each confirmed as an actual candidate road sign, or rejected as a false positive erroneously detected as a road sign in the first stage. For instance, in relation to the potential road sign 206, four frames 202C, 202D, 202E, and 202F of the frames 202 of the FOV video data 200 may include the potential road sign 206. The frames 202C, 202D, 202E, and 202F are analyzed interdependently, to assess motion of the potential road sign 206 throughout these frames. If the motion of the potential road sign 206 conforms with expected recorded video behavior of a road sign as a vehicle in which the camera recording such video moves the past the road sign, then the potential road sign 206 is confirmed as an actual candidate road sign, and is otherwise rejected as a false positive.

For example, in FIG. 2, the potential road sign 206 increases in apparent size in proceeding from the frame 202C to the frame 202F via the frames 202D and 202E, where at the last frame 202F just a portion of the road sign 206 is within the FOV of the video data 200. Furthermore, the potential road sign 206 moves to the right within the FOV in proceeding from the frame 202C to the frame 202F via the frames 202D and 202E. Both of these characteristics of the motion of the potential road sign 206 conform to expected behavior of a road sign recorded from a camera in a vehicle moving past the road sign, and as such the potential road sign 206 may be confirmed as an actual candidate road sign within the FOV video data 200. Other techniques can also be employed in performing such confirmation or rejection of a potential road sign as an actual candidate road sign, as described in detail below.

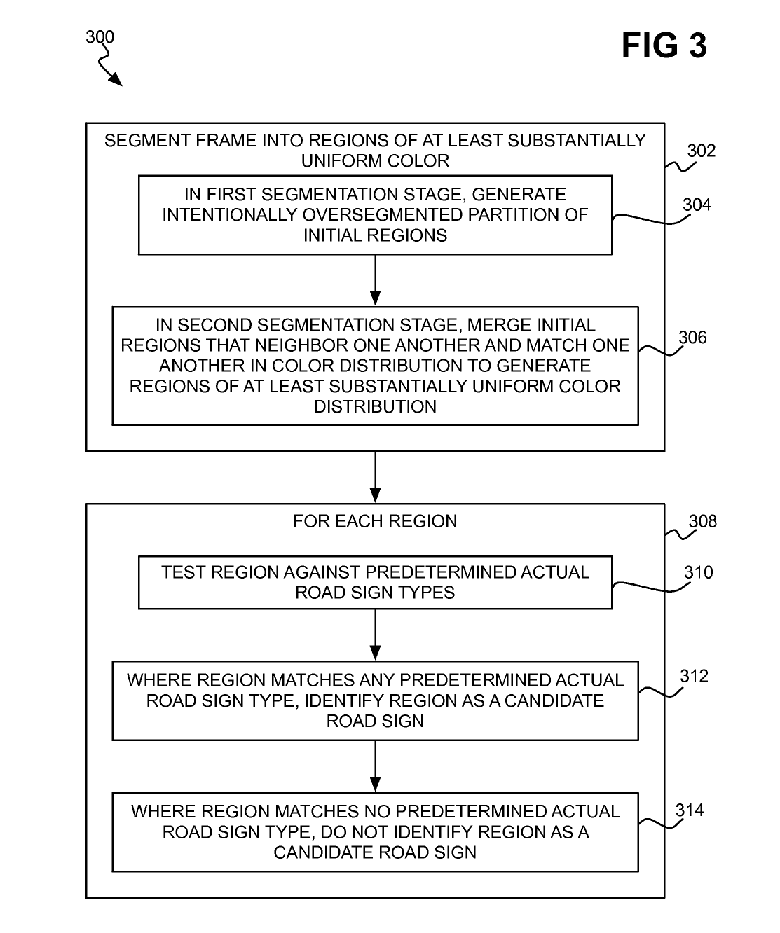

FIG. 3 shows an example method 300 for performing the initial candidate road sign identification of the first stage of part 102 of the method 100. The method 300 is performed for each frame of the FOV video data. The frame in question is segmented into regions of at least substantially uniform color (302). At least substantially uniform color may mean that no two pixels or sub-regions of a given region differ in color by more than a predetermined threshold, for instance.

Such segmentation of a frame into substantially uniform color regions can be achieved as follows. In a first segmentation stage, an intentionally or purposefully over-segmented partition of initial regions is generated (304). Such over-segmentation is performed such that no initial region includes both part of a road sign and part of image data that is not considered a road sign. That is, each initial region is part of a road sign or is not part of a road sign, but does not include both image data regarding a road sign as well as image data that is not regarding a road sign. For example, the frame may include a road sign and background objects like the road, trees, and so on. Each initial region may include a part of the road sign or part of a background object, but not parts of both.

However, at least one road sign is divided over two or more initial regions. That is, such a road sign is not completely within one initial region, but rather two or more initial regions constitute the road sign. In both of these respects, the first segmentation stage is thus said to be an over-segmented partition of the frame that is intentional and purposeful. That is, the partition is over-segmented because at least one road sign is divided over two or more initial regions. Furthermore, such over-segmentation is performed on purpose, so that no initial region is not part of both a road sign and a non-road sign background object, although at least one road sign may itself be made up of more than one initial region.

In a second segmentation stage, initial regions that neighbor one another and match one another in color distribution are merged together to generate a region of at least substantially uniform color distribution (306). The result of part 306 is the collection of these regions. By merging the smaller, initial regions into larger regions, the resulting larger regions are each either a candidate road sign or a background object.

This is because no initial region includes portions of both a candidate road sign and a background object, and because initial regions are merged together on a neighboring and color distribution-matching basis.

In one implementation, the two segmentation stages of parts 304 and 306 are performed as different parts of a connected component analysis. The first part of such a connected component analysis can be performed with an extended stencil to effectuate the first segmentation stage of part 304 to accommodate pixel noise within the frame of the FOV video data. The second part of such a connected component analysis is then performed on a graph of the initial regions that have been identified. Connected component analysis is also referred to as connected component labeling, blob extraction or discovery, as well as region labeling and extraction. This type of analysis is an algorithmic application of graph theory, in which subsets of connected components are labeled based on a heuristic.

For each region of at least substantially uniform color into which the frame has been segmented in part 302, the following is performed (308). The region is tested against predetermined actual road sign types (310). That is, a variety of different road sign types have been previously enrolled or registered as being valid road sign types that are to be detected within FOV video data. The road sign types may be particular to a specific region of the world, such as a particular continent or country. For example, the road signs used in the United States vary somewhat from those used in Canada, and vary dramatically from those employed in Europe. Therefore, the detection and tracking techniques disclosed herein can be particular to a certain region of the world if so desired; a vehicle driven in the United States, for example, is likely never to be driven in a European country.

More specifically, testing can be achieved by shape, size, and/or color. For a combination of these attributes, an acceptance range is defined to allow for variation of appearance of such signs in the FOV video data. For example, for a standard American freeway guide sign, a rectangular shape of various heights, widths, and aspect ratios is defined, with possibility addition or inclusion of an exit number tab on the top of the sign.

If a region matches any of the predetermined actual road sign types, then the region is identified, specified, and considered as a candidate road sign (312). Otherwise, if the region does not match any predetermined actual road sign type, the region is not identified as a candidate road sign (314). That is, in part 314, the region is specified as not being a candidate road sign. As noted above, potential candidate road signs are subsequently subjected to a second stage of analysis to determine whether a potential candidate road sign is in actuality a candidate road sign or not. As such, the initial detection performed in the method 300 can include false positives, but desirably does not include exclude any actual road sign that is present within the FOV video data.

In one implementation, testing a region against enrolled or preregistered actual road sign types in part 310 is performed as follows. A generalized Hough transform is employed on edge pixels of edges of the region. The Hough transform is a feature extraction technique that is used to locate imperfect instances of objects within a certain class of shapes by a voting process. This transform provides robustness as to outlying and missing edge pixels within the region, and further accommodates in-plane rotation any predetermined actual road sign type that may be present within the region. For instance, due to poor image quality, the edges of regions are often noisy, and correspond just roughly to the edges of a particular road sign. Furthermore, the interior of such regions can be hollow and some parts of the edges completely missing.

The generalized Hough transform of the region is then tested against each such predetermined actual road sign type, such as a generalized Hough transform of each such predetermined actual road sign type. This testing determines whether a region corresponds in shape, in size, and in color to a predetermined actual road sign type. Specifically, if for a given shape a best fit of the region against a particular predetermined actual road sign type has sufficient percentage of support among its edge pixels and satisfies size and color constraints of this road sign type, then the region is considered a candidate road sign of this type.

In one implementation, if a region does not correspond in all three of these characteristics of a particular predetermined actual road sign type, then the region is not considered to be a candidate road sign of this type. Shape can be important, as different predetermined actual road sign types can have different shapes. Size—and more specifically relative size—can be important, as predetermined actual road sign types commonly vary in size in relation to one another. Color can be important, since different predetermined actual road sign types can have different colors as well.

For instance, road signs in the United States include green directional signs that are rectangular in shape and which may have tabs on top. American road signs also include rectangular- and rhombus-shaped yellow warning signs and orange construction signs. Road signs in the United States further include white speed limit signs, blue informational signs, and vertical green milepost signs. Different predetermined actual road sign types corresponding to these types of signs may be enrolled a priori for testing each region against in part 310. A given predetermined actual road sign type loosely defines a certain range of combinations of color, size, and shape of actual road signs.

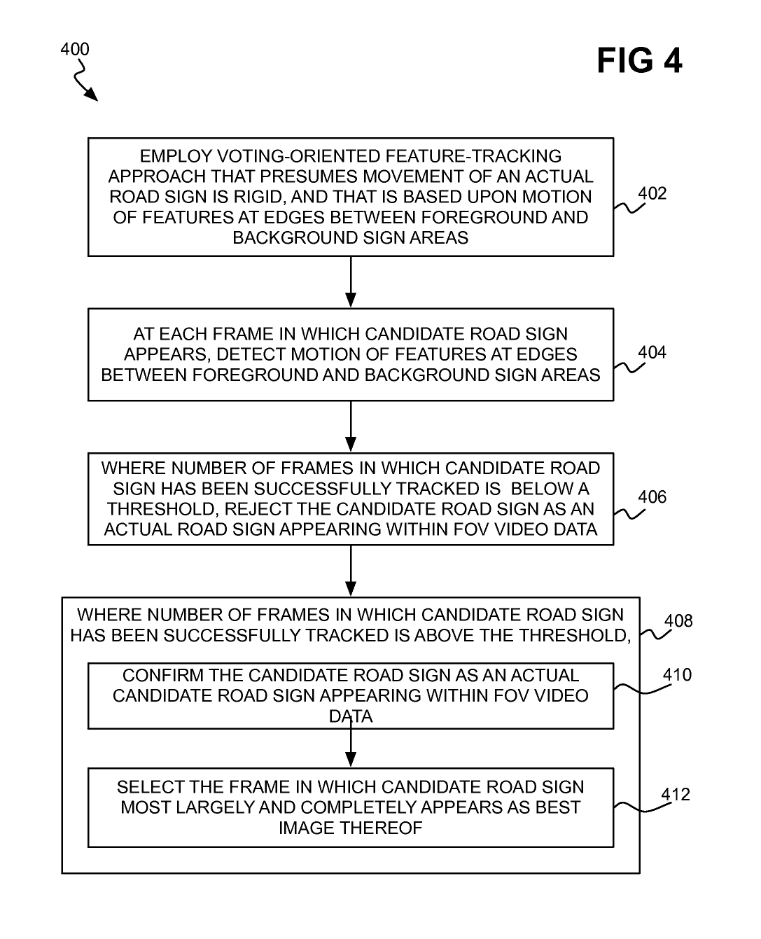

FIG. 4 shows an example method 400 for performing the confirmation or rejection of each candidate road sign of the second stage of part 104 of the method 100. The method 400 is performed for each candidate road sign that was identified or detected in the first stage of part 102 of the method 104. A voting-oriented feature-tracking approach is employed (402), which presumes two constraints regarding motion of an actual road sign within frames of the FOV video data. First, the motion of an actual road sign within the frames of the FOV video data is rigid. That is, a road sign can move among the frames just in a translation or a scaling sense, and in no other manner. As such, any candidate road sign that does not have this type of rigid motion within the FOV video data is rejected as not being an actual road sign.

Second, the motion of an actual road sign takes into account the motion of features of such a road sign between foreground and background sign areas. An actual road sign has foreground features and background features. For example, an American exit road sign has white letters, numbers, and arrows in the foreground against a green background. As another example, an American speed limit road sign has black letters and numbers in the foreground against a white background. The edges between these foreground features and these background features within an actual road sign remain pronounced to at least some degree even in low-quality FOV video data. Therefore, any candidate road sign that has insufficient local contrast, orient gradient features at detected edges between such foreground and background sign areas is rejected as not being an actual candidate road sign.

Therefore, the approach employed in part 402 is a feature-tracking approach in that the edges between areas of low contrast foreground features and high contrast background features, or between areas high contrast foreground features and low contrast background features, of a candidate road sign are considered. The approach employed in part 402 is a voting-oriented approach in that the extent to which the edges between the foreground and background features is present within multiple frames of the FOV video data is taken into account as well. In tracking these features, the approach further confirms that their motion adheres to the rigidity constraint as well.

In performing or employing the voting-oriented feature-tracking approach, then, at each frame of the subset (or more) of frames of the FOV video data in which the candidate road sign appears, the motion of the features at the edges between the foreground sign areas and the background sign areas within the candidate road sign is detected (404). It is noted that a candidate road sign typically appears in more than one frame of the FOV video data, but less than all the frames of the FOV video data. The motion of the features of the candidate road sign within these frames is considered. Dynamically considering the motion within the frames in such an interdependent manner also ensures that no candidate road sign is counted twice—that is, that an actual candidate road sign appearing within the FOV video data is considered as just one road sign, and not as two (or more) road signs.

Specifically, for each candidate road sign, in each frame in which the road sign in question appears, it is determined whether the candidate road sign has sufficiently supported motion between the frame in question and the a subsequent frame. If for a given frame a candidate road sign is deemed to have sufficiently supported motion to a subsequent frame, then it is concluded that the candidate road sign has been successfully tracked within this frame. As such, the number of frames in which the candidate road sign has been successfully tracked—is effectively counted. It is noted that a candidate road sign may within a series of frames drop out and then reappear, in terms of having sufficiently supported motion. Therefore, for example, even if a candidate road sign appears in X continuous frames, tracking of this road sign may be considered as having been established for just Y frames of the X frames, where Y<X.

Determining whether a candidate road sign has sufficiently supported motion between a given frame and a subsequent frame can be determined as follows. Edge features of the candidate road sign are defined as high-contrast edges between foreground and background areas within the road sign. A road sign typically has dark characters on a light background, or vice-versa, for instance, and some road signs have dark areas, such as boxes, on a light background, or vice-versa. The motion of each such edge feature of the candidate road sign between a given frame and a subsequent frame is detected.

As such, if a sufficient number of the edge features have moved in a translation or a scaling sense (i.e., rigidly), then it is concluded that the candidate road sign has motion between the given frame and the subsequent frame in question. That is, it is concluded that the candidate road sign has sufficiently supported motion—i.e., as sufficiently supported by the edge features thereof—to be deemed as having been successfully tracked within the given frame. In this respect, that a sufficient number of edge features support the same motion can be determined by comparing an actual number of the edge features that support the same motion against a threshold, by comparing a percentage of the total number of edge features that support the same motion against a threshold, and so on.

For example, an edge feature may be a vertical edge between black and white areas at a pixel having x and y coordinates of (125, 48) within a given frame. In the next frame there may be many pixels with such vertical edges. As an example, if the pixel at the position (137, 51) is one of these pixels (i.e., contains a vertical edge between black and white areas), then the edge feature in question could have moved by twelve pixels in the x direction and three pixels in the y direction, i.e. it supports the (12,3) motion (although it should be noted that the pixel can support multiple motions). If more than a certain threshold number of the candidate road sign's features support the same motion, then it is said that the candidate road sign has been successfully tracked between these two frames. It is noted that even if the candidate road sign is not tracked between these two frames, it can still be tracked from one frame to a different subsequent frame, however, albeit not the next and immediately adjacent frame, however.

If such tracking of a candidate road sign is successful for less than a predetermined threshold of frames (i.e., if the candidate road sign is not tracked through a sufficient number of frames), then the candidate road sign is rejected as an actual candidate road sign within the FOV video data (406). By comparison, if the tracking of a candidate road sign is successful for at least this predetermined threshold of frames (i.e., if the candidate road sign is tracked through a sufficient number of frames) (408), then the candidate road sign is confirmed (i.e., deemed as a valid candidate road sign) as an actual candidate road sign within the FOV video data (410). Furthermore, the frame in which the candidate road sign most completely (i.e., not cut off) and appears largest is selected as the best image of the candidate road sign that has been confirmed as an actual candidate road sign (412). The road sign may further be corrected for rotation if needed. Part 412 is performed so that subsequent interpretation of the road sign occurs on the basis of the best image thereof within the FOV video data.

The predetermined threshold against which the motion of the candidate road sign is compared in parts 406 and 408 thus corresponds to one or more of the following constraints. First, as noted above, where the candidate road sign is below the threshold, this can mean that the candidate road sign lacks a sufficient number of features at edges between foreground and background sign areas thereof to be considered an actual candidate road sign. Second, as also noted above, where the candidate road sign is below the threshold, this can mean that the candidate road sign is moving in a non-rigid manner such that it cannot be considered an actual candidate road sign.

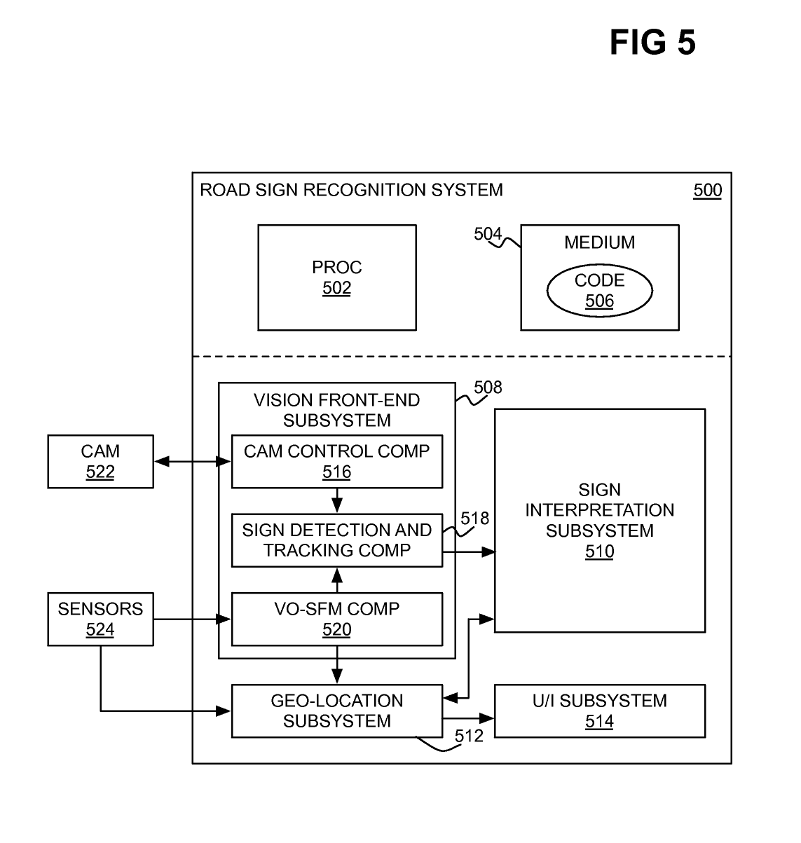

The methods that have been described can be performed by a processor of a computing device executing computer-executable code from and as stored on a non-transitory computer-readable data storage medium, like a hard disk drive, a semiconductor memory, and the like. In some implementations, the methods are performed in the context of a road sign recognition system, such as an enhanced situational awareness system. FIG. 5 shows an example of such a road sign recognition system 500. The subsystems of the system 500 that are specific to road sign detection and tracking as performed via the methods disclosed herein are shown in and described in more detail, whereas the other subsystems that are tangentially related are shown in and described in less detail.

The road sign recognition system 500 includes a processor 502 and a computer-readable medium 504 that stores computer-executable code 506. The processor 502 executes the code 506 to implement a vision front-end subsystem 508, a sign interpretation subsystem 510, a geo-location subsystem 512, and a user interface subsystem 514. The vision front-end subsystem 508 includes a camera control component 516, a sign detection and tracking component 518, and a visual odometry (VO) and structure-from-motion (SFM) component 520.

The camera control component 516 interfaces with a camera 522, such as a video camera, that may be located with the road sign recognition system 500 within a moving vehicle. The camera control component 516 controls the camera 522, and receives FOV video data therefrom. The FOV video data has a particular field-of-view, which is why it is referred to as FOV video data.

The VO-SFM component 520 may receive information from one or more other sensors 524, where present, and which may include GPS sensors, motion sensors, and so on. For instance, the sensors 524 may include the speedometer of the vehicle itself, which indicates speed, as well as a compass sensor, which indicates direction. The VO-SFM component 520 uses the FOV video data taken by the camera 522 and any additional sensor information from the sensors 524 to estimate motion of the camera 522, and thus the vehicle odometry, and a three-dimensional structure of the scene of the FOV video data.

The sign detection and tracking component 518 performs the methods that have been described herein, to identify candidate road signs and to then confirm or reject each such candidate road sign as an actual candidate road sign appearing within the FOV video data. The sign detection and tracking component 518 outputs the detected and tracked actual candidate road signs to the sign interpretation subsystem 510, which interprets these candidate road signs to glean information therefrom, and thus which can be said to recognize the actual candidate road signs as being actual road signs or not. In this respect, the sign interpretation subsystem 510 interfaces with the geo-location subsystem 512. It is noted that the vehicle odometry provided by the VO-SFM component 520 may include locational information in-between the candidate road signs that are detected by the sign detection and tracking component 518.

The geo-location subsystem 512 contains localization information regarding the location in which the vehicle is present. The general or precise location of the vehicle is provided from the VO-SFM component 520, which can enrich this information based on road names, place names, distances, exit numbers, point-of-interest information, and so on, for instance. The sign interpretation subsystem 510 thus interacts with the geo-location subsystem 512 to retrieve and refine the locational information, on the basis of the information interpreted from the candidate road signs provided by the sign detection and tracking component. Ultimately, the user interface subsystem 514 provides a rich set of information regarding the current location of the vehicle as determined and enriched, for viewing and interaction by and with a user like the driver of the vehicle.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. As such and therefore, it is manifestly intended that this invention be limited only by the claims and equivalents thereof

We claim:

1. A method for road sign detection and tracking within field-of-view (FOV) video data having a plurality of frames, comprising:
within a first stage corresponding to road sign detection, identifying one or more candidate road signs within the FOV video data, by statically analyzing each frame of the FOV video data independently using a processor of a computing device to detect the one or more candidate road signs within the FOV video data; and
after identifying the one or more candidate road signs within the FOV video data by static analysis of each frame of the FOV video data independently within the first stage,
within a second stage corresponding to road sign tracking, confirming or rejecting each candidate road sign by dynamically analyzing the frames of the FOV video data interdependently using the processor, to consider whether edge features of each candidate road sign sufficiently support motion in a sufficient number of frames of the FOV video data in which the candidate road sign appears,
such that the first stage of the road sign recognition is a static analysis that considers each frame of the FOV video data independently, and the second stage is a dynamic analysis that considers the frames of the FOV video data interdependently.

2. The method of claim 1, wherein identifying the one or more candidate road signs within the FOV video data by statically analyzing each frame of the FOV video data independently to detect the one or more candidate road signs within the FOV video data comprises, for each frame of the FOV video data as a given frame:
segmenting the given frame into a plurality of regions of at least substantially uniform color, each region representing a potential candidate road sign;
for each region, as a given region,
testing the given region against a plurality of predetermined actual road sign types;
upon testing the given region, and in response to the given region not matching any of the predetermined actual road sign types, specifying that the given region is one of the one or more candidate road signs within the FOV video data; and
upon testing the given region, and in response to the given region not matching any of the predetermined actual road sign types, specifying that the given region is not one of the one or more candidate road signs within the FOV video data.

3. The method of claim 2, wherein segmenting the given frame into the regions of at least substantially uniform color comprises:
in a first segmentation stage, generating a purposefully over-segmented partition of initial regions in which no initial region includes both part of an actual road sign and part of non-actual road sign but in which at least one actual road sign is divided over two or more of the initial regions; and
in a second segmentation stage performed after the first segmentation stage, merging the initial regions that neighbor one another and that match one another in color distribution to generate the regions of at least substantially uniform color distribution.

4. The method of claim 3, wherein generating the purposefully over-segmented partition of the initial regions comprises performing a first part of connected component analysis with an extended stencil to accommodate pixel noise,
and wherein merging the initial regions that neighbor one another and that match one another in color distribution comprises performing a second part of connected component analysis on a graph of the initial regions.

5. The method of claim 2, wherein testing the given region against the predetermined actual road sign types comprises:
employing a generalized Hough transform on edge pixels of edges of the given region to provide robustness as to outlying and missing edge pixels and to accommodate in-plane rotation of any of the predetermined actual road sign types within the given region.

6. The method of claim 5, wherein testing the given region against the predetermined actual road sign types further comprises, upon employing the generalized Hough transform:
determining that as a result of the generalized Hough transform the given region matches a given predetermined actual road sign type of the predetermined actual road sign types where the given region corresponds in shape, size, and color to the given predetermined actual road sign type; and
determining that as a result of the generalized Hough transform the given region does not match the given predetermined actual road sign type where the given region does not correspond in shape, size, and color to the given predetermined actual road sign type.

7. The method of claim 1, wherein confirming or rejecting each candidate road sign as an actual road sign within the FOV video data by dynamically analyzing the frames of the FOV video data interdependently comprises, for each candidate road sign as a given candidate road sign:
employing a voting-oriented feature-tracking methodology that presumes movement of an actual road sign within the FOV video data is rigid and that is based upon motion of the edges features defined on high-contrast edges between foreground sign areas and background sign areas within the given candidate road sign.

8. The method of claim 7, wherein confirming or rejecting each candidate road sign as an actual candidate road sign within the FOV video data by dynamically analyzing the frames of the FOV video data interdependently further comprises, for each candidate road sign as the given candidate road sign, in employing the voting-oriented feature tracking methodology:
at each frame of at least a sub-plurality of the frames of the FOV video, detecting the motion of the edge features within the given candidate road sign, and counting a number of the frames of the FOV video in which the given candidate road sign has sufficiently supported motion by the edge features;
where the number of the frames in which the given candidate road sign has sufficiently supported motion by the edge features is less than a predetermined threshold, rejecting the given candidate road sign as an actual candidate road sign within the FOV video data; and
where the number of the frames in which the given candidate road sign has sufficiently supported motion by the edge features is greater than the predetermined threshold, confirming the given candidate road sign as an actual candidate road sign within the FOV video data.

9. The method of claim 8, wherein confirming or rejecting each candidate road sign as an actual road sign within the FOV video data by dynamically analyzing the frames of the FOV video data interdependently further comprises, for each candidate road sign as the given candidate road sign, in employing the voting-oriented feature-tracking methodology:
where the number of the frames in which the given candidate road sign has sufficiently supported motion by the edge features is greater than the predetermined threshold,
selecting a particular frame of the at least the sub-plurality of the frames of the FOV video in which the given candidate road sign most largely appears, as a best image of the given candidate sign that has been confirmed as an actual candidate road sign within the FOV video data.

10. A road sign detection and tracking component of a vision front-end subsystem of a road sign recognition system, comprising:
a processor;
a non-transitory computer-readable data storage medium storing computer-executable code executable by the processor to:
within a first stage corresponding to road sign detection, identify one or more candidate road signs within the FOV video data, by statically analyzing each frame of the FOV video data independently to detect the one or more candidate road signs within the FOV video data; and
after identifying the one or more candidate road signs within the FOV video data by static analysis of each frame of the FOV video data independently within the first stage,
within a second stage corresponding to road sign tracking, confirm or reject each candidate road sign by dynamically analyzing the frames of the FOV video data interdependently, to consider whether edge features of each candidate road sign sufficiently support motion in a sufficient number of frames of the FOV video data in which the candidate road sign appears,
such that the first stage of the road sign recognition is a static analysis that considers each frame of the FOV video data independently, and the second stage is a dynamic analysis that considers the frames of the FOV video data interdependently.

11. The road sign detection and tracking component of claim 10, wherein the computer-executable code is executable by the processor to identify the one or more candidate road signs within the FOV video data by statically analyzing each frame of the FOV video data independently to detect the one or more candidate road signs within the FOV video data by, for each frame of the FOV video data as a given frame:
segmenting the given frame into a plurality of regions of at least substantially uniform color, each region representing a potential candidate road sign;
for each region, as a given region,
testing the given region against a plurality of predetermined actual road sign types;
upon testing the given region, and in response to the given region matching any of the predetermined actual road sign types, specifying that the given region is one of the one or more candidate road signs within the FOV video data; and
upon testing the given region, and in response to the given region not matching any of the predetermined actual road sign types, specifying that the given region is not one of the one or more candidate road signs within the FOV video data.

12. The road sign detection and tracking component of claim 11, wherein the computer-executable code is executable by the processor to segment the given frame into the regions of at least substantially uniform color by:
in a first segmentation stage, generating a purposefully over-segmented partition of initial regions in which no initial region includes both part of an actual road sign and part of non-actual road sign but in which at least one actual road sign is divided over two or more of the initial regions; and
in a second segmentation stage performed after the first segmentation stage, merging the initial regions that neighbor one another and that match one another in color distribution to generate the regions of at least substantially uniform color distribution.

13. The road sign detection and tracking component of claim 10, wherein the computer-executable code is executable by the processor to confirm or reject each candidate road sign as an actual road sign within the FOV video data by dynamically analyzing the frames of the FOV video data interdependently by, for each candidate road sign as a given candidate road sign:
employing a voting-oriented feature-tracking methodology that presumes movement of an actual road sign within the FOV video data is rigid and that is based upon motion of the edges features defined on high-contrast edges between foreground sign areas and background sign areas within the given candidate road sign;
at each frame of at least a sub-plurality of the frames of the FOV video, detecting the motion of the edge features within the given candidate road sign, and counting a number of the frames of the FOV video in which the given candidate road sign has sufficiently supported motion by the edge features;
where the number of the frames in which the given candidate road sign has sufficiently supported motion by the edge features is less than a predetermined threshold, rejecting the given candidate road sign as an actual candidate road sign within the FOV video data; and
where the number of the frames in which the given candidate road sign has sufficiently supported motion by the edge features is greater than the predetermined threshold, confirming the given candidate road sign as an actual candidate road sign within the FOV video data.

14. A non-transitory computer-readable data storage medium storing computer-executable code executable by a processor of a computing device to a perform a method comprising:
within a first stage corresponding to road sign detection, identifying one or more candidate road signs within the FOV video data, by statically analyzing each frame of the FOV video data independently to detect the one or more candidate road signs within the FOV video data; and
after identifying the one or more candidate road signs within the FOV video data by static analysis of each frame of the FOV video data independently within the first stage,
within a second stage corresponding to road sign tracking, confirming or rejecting each candidate road sign by dynamically analyzing the frames of the FOV video data interdependently, to consider whether edge features of each candidate road sign sufficiently support motion in a sufficient number of frames of the FOV video data in which the candidate road sign appears,
such that the first stage of the road sign recognition is a static analysis that considers each frame of the FOV video data independently, and the second stage is a dynamic analysis that considers the frames of the FOV video data interdependently.

15. The non-transitory computer-readable data storage medium of claim 14, wherein identifying the one or more candidate road signs within the FOV video data by statically analyzing each frame of the FOV video data independently to detect the one or more candidate road signs within the FOV video data comprises, for each frame of the FOV video data as a given frame:
segmenting the given frame into a plurality of regions of at least substantially uniform color, each region representing a potential candidate road sign;
for each region, as a given region,
testing the given region against a plurality of predetermined actual road sign types;
upon testing the given region, and in response to the given region matching any of the predetermined actual road sign types, specifying that the given region is one of the one or more candidate road signs within the FOV video data; and
upon testing the given region, and in response to the given region not matching any of the predetermined actual road sign types, specifying that the given region is not one of the one or more candidate road signs within the FOV video data.

16. The non-transitory computer-readable data storage medium of claim 15, wherein segmenting the given frame into the regions of at least substantially uniform color comprises:
in a first segmentation stage, generating a purposefully over-segmented partition of initial regions in which no initial region includes both part of an actual road sign and part of non-actual road sign but in which at least one actual road sign is divided over two or more of the initial regions; and
in a second segmentation stage performed after the first segmentation stage, merging the initial regions that neighbor one another and that match one another in color distribution to generate the regions of at least substantially uniform color distribution.

17. The non-transitory computer-readable data storage medium of claim 15, wherein confirming or rejecting each candidate road sign as an actual road sign within the FOV video data by dynamically analyzing the frames of the FOV video data interdependently comprises, for each candidate road sign as a given candidate road sign:
employing a voting-oriented feature-tracking methodology that presumes movement of an actual road sign within the FOV video data is rigid and that is based upon motion of the edges features defined on high-contrast edges between foreground sign areas and background sign areas within the given candidate road sign;
at each frame of at least a sub-plurality of the frames of the FOV video, detecting the motion of the edge features within the given candidate road sign, and counting a number of the frames of the FOV video in which the given candidate road sign has sufficiently supported motion by the edge features;
where the number of the frames in which the given candidate road sign has sufficiently supported motion by the edge features is less than a predetermined threshold, rejecting the given candidate road sign as an actual candidate road sign within the FOV video data; and
where the number of the frames in which the given candidate road sign has sufficiently supported motion by the edge features is greater than the predetermined threshold, confirming the given candidate road sign as an actual candidate road sign within the FOV video data.
